(19) United States
(12) Patent Application Publication
(10) Pub. No.: US 2012/0285056 A1
(43) Pub. Date: Nov. 15, 2012

(54) System and Method for Maintaining Animal Ear Tags

(76) Inventor: Eugenio Corrales, JR., Dimmitt, TX (US)

(21) Appl. No.: 13/104,659

(22) Filed: May 10, 2011

(51) Int. Cl. G09F 3/00; A01K 29/00

(52) U.S. Cl. 40/301

(57) ABSTRACT

A system and method for maintaining animal ear tags are disclosed. Said system comprising an animal ear tag. Said animal ear tag comprises a body, a control chemical, one or more identifiers, and an ear attachment assembly. Said ear attachment assembly is capable of attaching to an ear of an animal. Said body and said ear attachment assembly are one-piece. Said method comprising attaching one or more identifiers to an animal ear tag having a body and an ear attachment assembly, and attaching said ear attachment assembly to an ear of an animal. Said body and said ear attachment assembly are one-piece. A portion of said animal ear tag comprises a control chemical capable of protecting said animal.

### BACKGROUND

This disclosure relates to a system and method for maintaining animal ear tags.

Animal ear tags are objects used for identification of an animal, such as domestic livestock and other animals. In many cases, animal ear tags are a plastic or metallic object. An animal ear tag usually carries a printed identifier, such as an identification number or code for said animal, or for its herd and/or flock. This printed identifier may be assigned by some national organizations (usually in the form of Property Identification Code, or PIC), or may be handwritten for the convenience of the user. An ear tag can be applied with an ear tag applicator (also called pliers, or an applicator), however there are also specially designed tags that can be applied by hand. Very small ear tags are available for laboratory animals such as mice and rats.

Animal ear tags were developed as early as 1913 as a means to identify cattle when testing for tuberculosis. Today, ear tags in a variety of designs are used throughout the world on many species of animals to ensure traceability, to help prevent theft and to control disease outbreaks. For example, some animal ear tags for cattle contain control chemicals such as a pesticide, to control insects such as buffalo fly etc.

Despite their great benefits, current embodiments of animal ear tags leave room for improvement.

In a common embodiment, a one-piece animal ear tag comprises a printed identifier, a body portion and an ear attachment assembly. Said printed identifier can be transferred to an animal ear tag by a variety of methods. For example, one method requires manually writing said printed identifier on each animal ear tag. However, such an embodiment is slow and prone to human error. In another method, a transfer procedure can be used; wherein, said transfer procedure comprises heating a stamp, pressing said stamp against a transfer paper, pressing said transfer paper and said stamp against said animal ear tag, and leaving behind said printed identifier once said transfer paper and said stamp are removed. A limitation of current one-piece animal ear tags is the lack of a control chemical. This limitation is due in part to the lack of a means of safely adding said printed identifier to said embodiment and meanwhile not damaging said control chemical. For example, in current embodiments, adding a printed identifier may cause harm to said control chemical due to said transfer procedure (or similar) because said heating step in said transfer procedure can harm said control chemical. Likewise, where said one-piece animal ear tag has been dipped in a chemical, that chemical treatment will be harmed in said transfer procedure.

In another common embodiment, a multi-piece control chemical animal ear tag can comprise a body portion and an ear attachment assembly; wherein a portion of said multi-piece control chemical animal ear tag comprises a control chemical for medical or pest control purposes, and said ear attachment assembly comprises a plurality of separate elements. Said multi-piece control chemical animal ear tag can help protect said animal from pests or provide medication to said animal by releasing said chemicals into the hair, skin, and blood stream. However, said multi-piece control chemical animal ear tag lacks the convenience of other animal ear tags. For example, said multi-piece control chemical animal ear tag lacks the convenience of a one-piece animal ear tag. Generally, multi-piece tags present several limitations in practice. First, multi-piece tags are cumbersome requiring a user to keep up with multiple portions when attaching to an animal. Further, multi-piece tags are more prone to damage and detachment from an animal due to breakage between said first portion and said second portion. Further, multi-piece tags are difficult to remove from an animal because said ear attachment assembly can require a prying force to detach its portions and said prying force may be difficult to apply when in an animal's ear. Likewise, current embodiments of said multi-piece control chemical animal ear tags lack the simultaneous use of a control chemical and an identifier.

In another embodiment, a RFID animal ear tag was introduced comprising a body portion, an ear attachment assembly capable of attaching to an animal's ear, a printed identifier, and a RFID chip; wherein said RFID chip is capable of being wirelessly read by a RFID reader. Said RFID animal ear tag provides the convenience of machine tracking said animal. However, said RFID animal ear tags do not provide a control chemical in addition to their RFID features.

Current animal ear tag users are now faced with the difficult choice of choosing between said one-piece animal ear tags, said multi-piece control chemical animal ear tag, or said RFID animal ear tags. Accordingly, said animal ear tag user is required to purchase, apply, and maintain multiple animal ear tags to accomplish the full range of features an animal ear tag can provide. Accordingly, it would be useful to have an improved system and method for maintaining animal ear tags.

### SUMMARY

A system for maintaining animal ear tags is disclosed. Specifically, said system comprising an animal ear tag. Said animal ear tag comprises a body, a control chemical, one or more identifiers, and an ear attachment assembly. Said ear attachment assembly is capable of attaching to an ear of an animal. Said body and said ear attachment assembly are one-piece.

### BRIEF DESCRIPTION OF THE DRAWINGS

FIG. 1A and FIG. 1B illustrate a front and back view of a system for maintaining animal ear tags with a first ear attachment assembly.

FIGS. 2A and 2B illustrate a detailed front and back view of first ear attachment assembly.

FIGS. 2C and 2D illustrate a front and back view of a sharpened ear attachment assembly.

FIGS. 3A and 3B illustrate an above and a below view of a stamping system, respectively.

FIGS. 4A and 4B illustrate a plurality of alternative embodiments of body and ear attachment assembly.

FIGS. 5A and 5B illustrate an applicator.

FIGS. 6A and 6B illustrate system for maintaining animal ear tags attached to applicator and ready to be inserted into said animal's ear.

FIG. 7 illustrates a bovine and system for maintaining animal ear tags with applicator in said pre-application position

FIG. 8 illustrates system for maintaining animal ear tags attached to bovine.

### DETAILED DESCRIPTION

Described herein is a system and method for maintaining animal ear tags. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

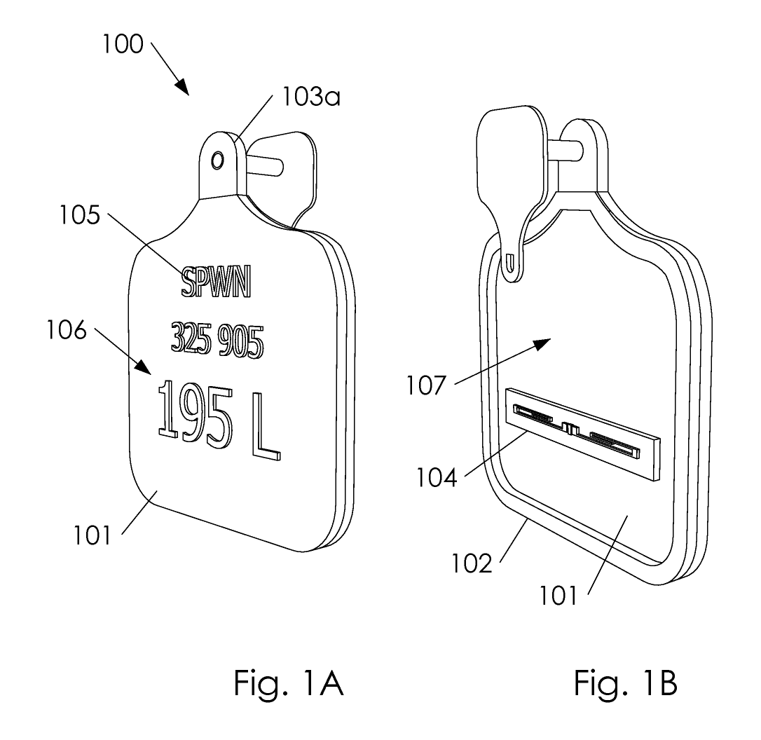

FIG. 1A and FIG. 1B illustrate a front and back view of an animal ear tag 100 with a first ear attachment assembly 103a. System and method for maintaining animal ear tags can comprise one or more animal ear tags 100. Animal ear tag 100 can comprise a body 101, a control chemical element 102, an ear attachment assembly 103, and one or more identifiers. Said identifier can comprise an electronic signaler 104 or a printed identifier 105. In one embodiment, said identifier can be capable of containing identifying information associated with an animal. In one embodiment, printed identifier 105 can be capable of visual interpretation. For example, in one embodiment, printed identifier 105 can comprise a printed message capable of being visually read and understood by a human. In another embodiment, printed identifier 105 can comprise a bar code capable of being visually read and understood by a machine. In one embodiment, ear attachment assembly 103 can comprise first ear attachment assembly 103a, as in FIGS. 1A-1B. In one embodiment, body 101 can comprise a first side 106 and a second side 107. In one embodiment, body 101 and ear attachment assembly 103 can be one-piece, being made of the same material without a break between them. In one embodiment, said system and method for maintaining animal ear tags can comprise attaching one or more identifiers to animal ear tag 100, attaching ear attachment assembly 103 to an ear of an animal; wherein body 101 and ear attachment assembly 103 can be one-piece, and a portion of animal ear tag 100 can comprise said control chemical.

In one embodiment, a portion of animal ear tag 100 can comprise a control chemical for protecting an animal. For example, in one embodiment, said control chemical can comprise a pesticide, a medication, a multivitamin, or a combination of these chemicals. In one embodiment, said pesticide can comprise any substance or mixture of substances intended for preventing, destroying, repelling or mitigating any pest. In one embodiment, said pesticide can comprise a migratory and volatile pesticide. In another embodiment, said pesticide can comprise at least one migratory and vaporizable (or exudable) pesticide. In one embodiment, said medication can comprise a pharmaceutical drug, also referred to as medicine or medicament, loosely defined as any chemical substance intended for use in the medical diagnosis, cure, treatment, or prevention of disease. In one embodiment, said multivitamin can comprise a chemical substance intended to supplement said animal's diet with vitamins, dietary minerals and other nutritional elements. In another embodiment, said multivitamin can comprise a chemical substance for assisting with the growth and development of an animal.

In one embodiment, said animal ear tag 100 can administer said control chemical to an animal by releasing said control chemical into the animal's hair and skin through contact. Further, in such an embodiment, said control chemical can enter said animal's blood stream and thereby deliver said control chemical to the rest of said animal's body.

In one embodiment, said control chemical can be added to animal ear tag 100 by a dipping procedure, as known in the art. In one embodiment, said dipping procedure can comprise heating a portion of animal ear tag 100, dipping said portion in said control chemical, removing said portion from said control chemical, and allowing said portion to cool. In another embodiment, animal ear tag 100 can be made by molding a compound of a plastic and said control chemical. In one embodiment, said plastic can comprise a material from any of a wide range of synthetic or semi-synthetic organic solids used in the manufacture of industrial products, as known in the art. In other embodiments, said plastic can comprise other plastic-like materials, such as vinyl, as would be obvious to those experienced in the art. In one embodiment, control chemical element 102 can comprise both body 101 and ear attachment assembly 103. In another embodiment, control chemical element 102 can be separate from but connected to body 101 and ear attachment assembly 103.

In such an embodiment, said control chemical can be administered by control chemical element 102. Further, in such an embodiment, control chemical element 102 can be manufactured separately from the rest of animal ear tag 100 and attached later. In such an embodiment, control chemical element 102 can also be replaced when said control chemical loses potency. Further, in such an embodiment, control chemical element 102 can avoid damage during the manufacture by being manufactured separately from the rest of animal ear tag 100. In one embodiment, control chemical element 102 can be attached to second side 107 and stretch around the edges of body 101.

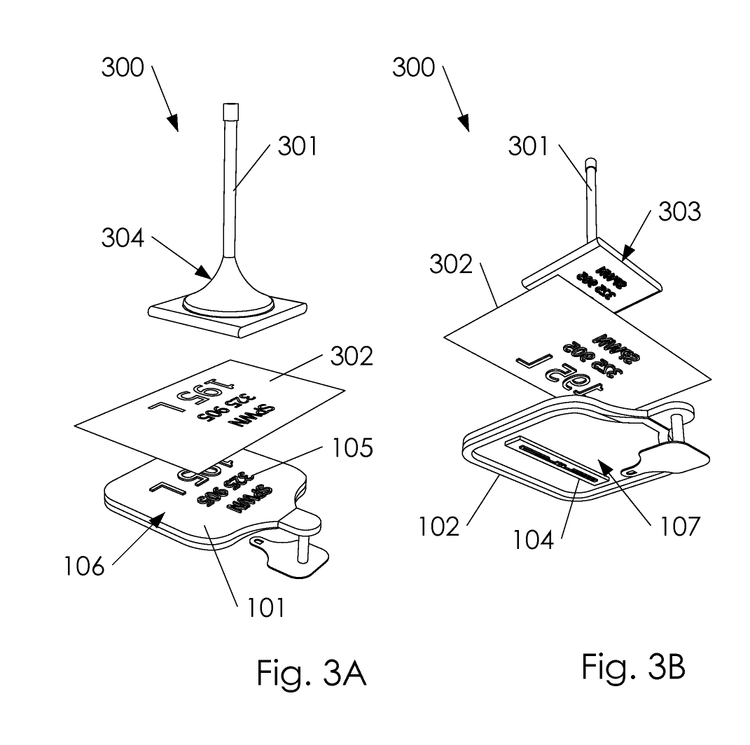

In one embodiment, first side 106 can comprise a substantially flat space large enough to accommodate printed identifier 105. In one embodiment, printed identifier 105 can be large enough to be read by users of animal ear tag 100 at typical distances, as is common in the art. In one embodiment, printed identifier 105 can comprise an identifier associated with an animal, an animal's owner, an animal's feed or medication requirements, an animal's assigned location, or similar as is known in the art. Printed identifier 105 can further comprise a barcode or other printed identifier capable of being read by an electronic code reader, such as a barcode reader. In one embodiment, printed identifier 105 can be imprinted onto body 101. In another embodiment, printed identifier 105 can be stamped onto body 101. In another embodiment, printed identifier 105 can be molded into body 101 at the time body 101 is molded. In another embodiment, printed identifier 105 can be added to body 101 by transferring printed identifier 105 to body 101 using a transfer procedure; said transfer procedure can comprise heating a transfer paper (commonly known as “tagging tape”) along a select path defined by a stencil, stamp or a brand (commonly known as a “slug”), as will be discussed infra in the detailed description of FIGS. 3A and 3B. In another embodiment, printed identifier 105 can be written on body 101 with a writing instrument, such as a permanent marker. In another embodiment, printed identifier 105 can be affixed to a medium and said medium can attach to said body 101. For example, in one embodiment, said medium can be a piece of tape, wherein printed identifier 105 can be printed onto said piece of tape which can be attached to body 101 by an adhesive on said piece of tape. Further, in another embodiment, said medium can comprise a tough material such as a textile; wherein printed identifier 105 can be sewn into or printed upon said medium, said medium can be attached to body 101 by an attaching means, such as a set of hook-and-loop fasteners or an adhesive. In one embodiment, said hook-and-loop fasteners can comprise corresponding parts of Velcro®, as known in the art.

In one embodiment, electronic identifier 104 can be attached to first side 106. In another embodiment, electronic identifier 104 can be attached to second side 107, as in FIG. 1B. In another embodiment, electronic identifier 104 can be attached to or inside of another portion of animal ear tag 100. In one embodiment, electronic identifier 104 can be attached by glue, hook-and-loop fasteners, pinned to body 101, or a similar attaching means as will be apparent to those experienced in the art. In one embodiment, electronic identifier 104 can comprise an identifier capable of being read by an electronic reader. For example, in one embodiment, said electronic reader can comprise an RFID reader and electronic identifier 104 can comprise an RFID tag; wherein, said RFID reader is capable of electronically reading said RFID tag. In one embodiment, said RFID tag can be capable of being read several meters away and beyond the line of sight of said RFID reader.

In one embodiment, animal ear tag 100 can comprise a one-piece ear tag, as known in the art, but can further comprise said control chemical, electronic signaler 104, and/or printed identifier 105. For example, in one embodiment, animal ear tag 100 can comprise control chemical element 102 and printed identifier 105; wherein, animal ear tag 100 can replace the need for multiple ear tags in said animal (one tag with printed identifier 105 and one tag with said control chemical). In another embodiment, a plurality of components can be included in a single ear tag; wherein said plurality of components can comprise a selection from control chemical element 102, electronic signaler 104, printed identifier 105, and control chemical element 102.

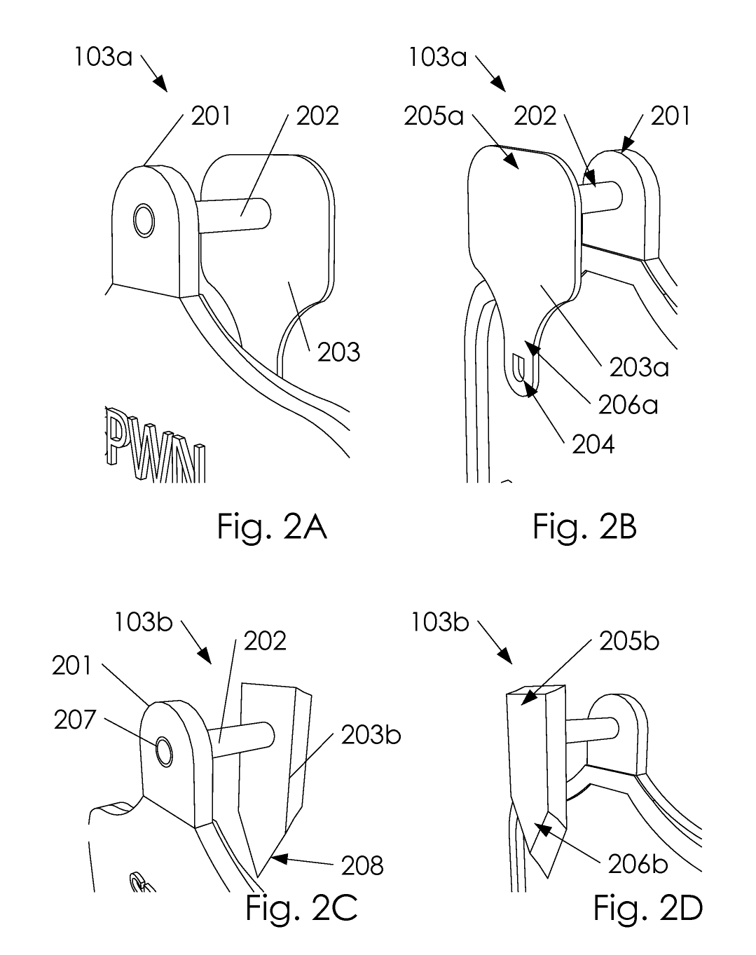

FIGS. 2A and 2B illustrate a detailed front and back view of first ear attachment assembly 103a. First ear attachment assembly 103a can comprise a neck 201, a shaft 202, a back portion 203a, and a slot 204.

In one embodiment, neck 201 can attach to body 101 as in FIGS. 1A-1B. In another embodiment, neck 201 can attach directly to control chemical element 102. In one embodiment, shaft 202 can connect back portion 203a to neck 201.

In one embodiment, shaft 202 can comprise a rectangular shape. In one embodiment, said rectangular shape can prevent animal ear tag 100 from rotating in an animal's ear. In another embodiment, shaft 202 can comprise a substantially cylindrical shape as show in FIGS. 2A and 2B. In such an embodiment, said cylindrical shape can allow animal ear tag 100 to rotate freely in an animal's ear.

Back portion 203a can comprise a first end 205a and a second end 206a. In one embodiment, first end 205a can be attached to shaft 202. In one embodiment, slot 204 can comprise a hole in second end 206a, as shown in FIGS. 2A and 2B. In one embodiment, back portion 203a can taper inward progressively from first end 205a to second end 206a. In one embodiment, second end 206a can comprise a rounded point shape. In one embodiment, slot 204 can be substantially in the center and end of second end 206a.

In one embodiment, neck 201 can be proportionately short as compared with body 101 in order to minimize exposure to breakage and accidental tearing by animals. For example, in one embodiment, the width and height of neck 201 can be only 10% the width of body 101. In one embodiment, neck 201 can be as short as possible thereby minimizing the animal's ability to scratch against hard surfaces (such as trees, posts, cables, etc.) and pull out animal ear tag 100.

FIGS. 2C and 2D illustrate a front and back view of a sharpened ear attachment assembly 103b. Ear attachment assembly 103 can comprise a sharpened ear attachment assembly 103b. In one embodiment, ear attachment assembly 103 can comprise sharpened ear attachment assembly 103b. Sharpened ear attachment assembly 103b can comprise a sharpened back portion 203b having a first end 205b and a second end 206b, a shaft eye 207, and a sharpened point 208. In one embodiment, second end 206b can comprise sharpened point 208 capable of piercing an animal's ear. Further, in another embodiment, shaft eye 207 can comprise an opening in neck 201 aligned with, and providing access to, the inside of shaft 202. For example, in one embodiment, an instrument can be inserted into shaft eye 207, through neck 201, into shaft 202, and touch a portion of sharpened back portion 203b attached to shaft 202.

FIGS. 3A and 3B illustrate an above and a below view of a stamping system 300, respectively. System and method for maintaining animal ear tags can further comprise stamping system 300. Stamping system 300 can comprise a stamp 301 and a transfer paper 302 (also known as “tagging tape” in the art). Stamp 301 can comprise a printed identifier mirror image 303 and a heating source 304.

In one embodiment, stamping system 300 can be capable of transferring printed identifier 105 to animal ear tag 100 by said transfer procedure, introduced supra. In one embodiment, printed identifier mirror image 303 can comprise a mirror image of printed identifier 105. In one embodiment, printed identifier mirror image 303 can comprise a portion of said stamp 301, raised to form said mirror image of printed identifier 105. In one embodiment, said transfer procedure can comprise heating printed identifier mirror image 303 with heating source 304, inserting an unused portion of transfer paper 302 between printed identifier mirror image 303 and body 101, pressing transfer paper 302 against body 101 with printed identifier mirror image 303, releasing a portion of transfer paper 302 on body 101 wherein said portion of transfer paper 302 comprises printed identifier 105 to transfer to body 101, and removing printed identifier mirror image 303 and transfer paper 302 from body 101. In one embodiment, animal ear tag 100 can be configured to ensure stamp 301 will not come into contact with portions of animal ear tag 100 likely to sustain injury by contact with a heated element. For example, in one embodiment, control chemical element 102 and electronic signaler 104 can be attached to second side 107 of body 101 and printed identifier 105 can be transferred to first side 106 of body 101, as in FIGS. 3A-3B. In one embodiment, said system and method for maintaining animal ear tags can comprise minimizing heat damage to control chemical element 102 during said transfer procedure by attaching control chemical element 102 to second side 107, transferring printed identifier 105 to first side 106, and insulating control chemical element 102 during said transfer procedure with body 101. In another embodiment, said transfer procedure can be applied to body 101 prior to attaching control chemical element 102 and/or electronic signaler 104 to body 101 in order to eliminate the possibility of harming components of animal ear tag 100 during said transfer procedure.

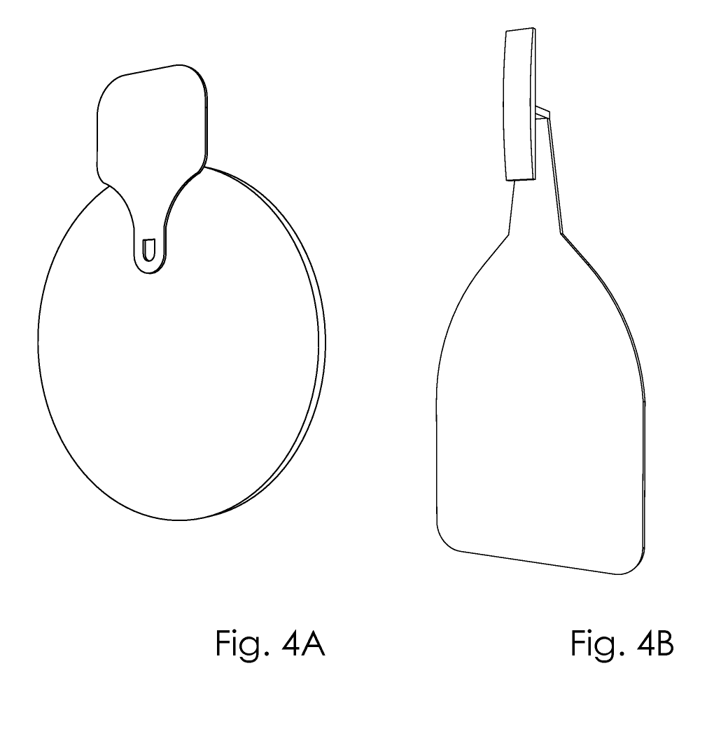

FIGS. 4A and 4B illustrate a plurality of alternative embodiments of body 101 and ear attachment assembly 103. In one embodiment, animal ear tag 100 can comprise said alternative embodiment of body 101 and ear attachment assembly 103. For example, FIG. 4A illustrates a substantially round version of body 101. Further, for example, FIG. 4B illustrates a substantially rectangular version of body 101 and an alternative embodiment of ear attachment assembly 103. In another embodiment, body 101 can be substantially rectangular with rounded edges, as in FIGS. 1A and 1B.

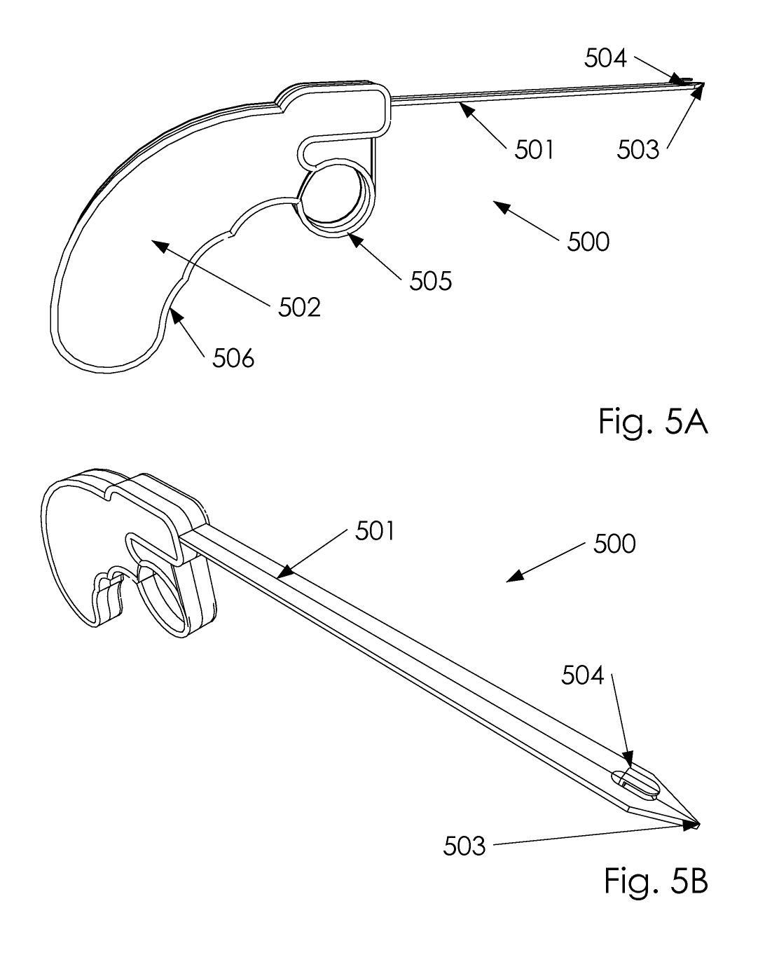

FIGS. 5A and 5B illustrate an applicator 500. System and method for maintaining animal ear tags can further comprise applicator 500. Applicator 500, commonly known as an “ear tagger” in the art, can comprise a blade 501 and a handle 502. Blade 501 can comprise a blade tip 503 and a hook 504. In one embodiment, blade 501 can be attached to handle 502 at one end and have blade tip 503 at the other end, as shown in FIGS. 5A and 5B. In another embodiment, blade tip 503 can be a sharpened point capable of breaking the skin and penetrating through an animal's ear. In another embodiment, hook 504 can be located proximate to blade tip 503. Further, in one embodiment, hook 504 can comprise a rounded tip rather than a sharp tip as is typical among fishing hooks. In one embodiment, hook 504 can attach to and rise substantially perpendicular from blade 501, turn substantially parallel to blade 501 and point toward blade tip 503.

Handle 502 can comprise an index finger slot 505 and a handle grip 506. In one embodiment, applicator 500 can be capable of piercing an animal's ear by gripping handle grip 506, inserting an index finger into index finger slot 505, thrusting applicator 500 against an animal's ear, and piercing said animal's ear with blade tip 503.

In another embodiment, animal ear tag 100 can be used with any known or yet to be developed alternative applicator as will be apparent to any person competent in the art.

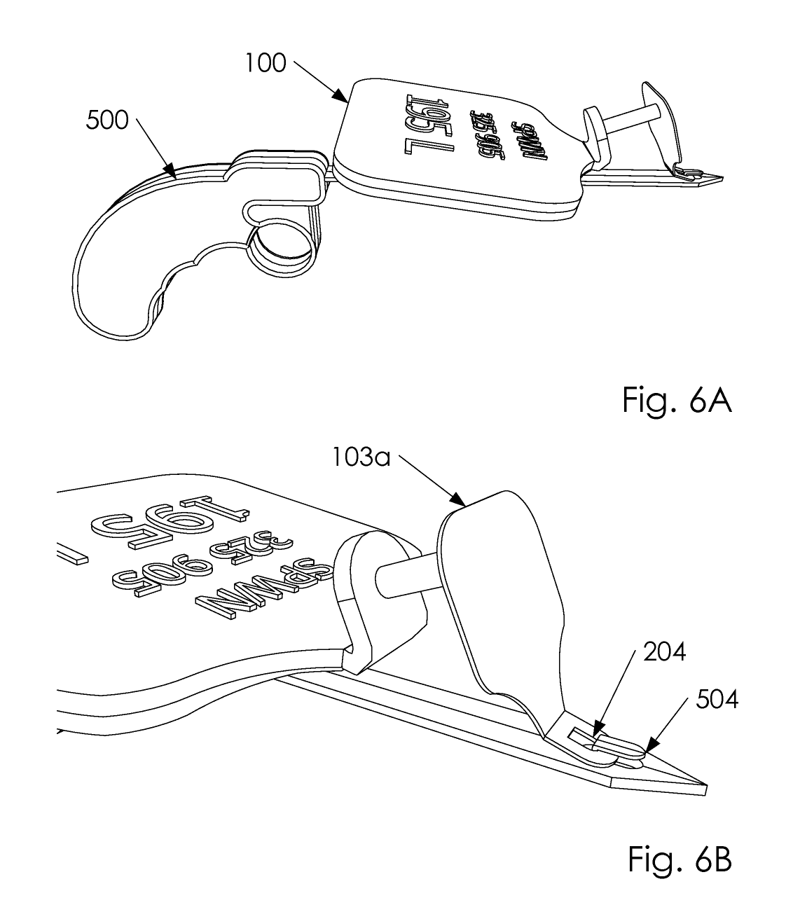

FIGS. 6A and 6B illustrate animal ear tag 100 attached to applicator 500 and ready to be inserted into said animal's ear. In one embodiment, animal ear tag 100 can be attached to applicator 500 by inserting hook 504 into slot 204. Ear attachment assembly 103a can be arranged in a pre-application position while attached to animal ear tag 100. In one embodiment, said pre-application position can comprise attaching animal ear tag 100 to applicator 500, bending ear attachment assembly 103a, allowing a portion of animal ear tag 100 to lay flat along blade 501 with printed identifier 105 substantially face up and applicator 500 substantially below animal ear tag 100, as shown in FIGS. 6A and 6B. In one embodiment, said pre-application position can be used to prepare animal ear tag 100 for insertion into an ear of an animal.

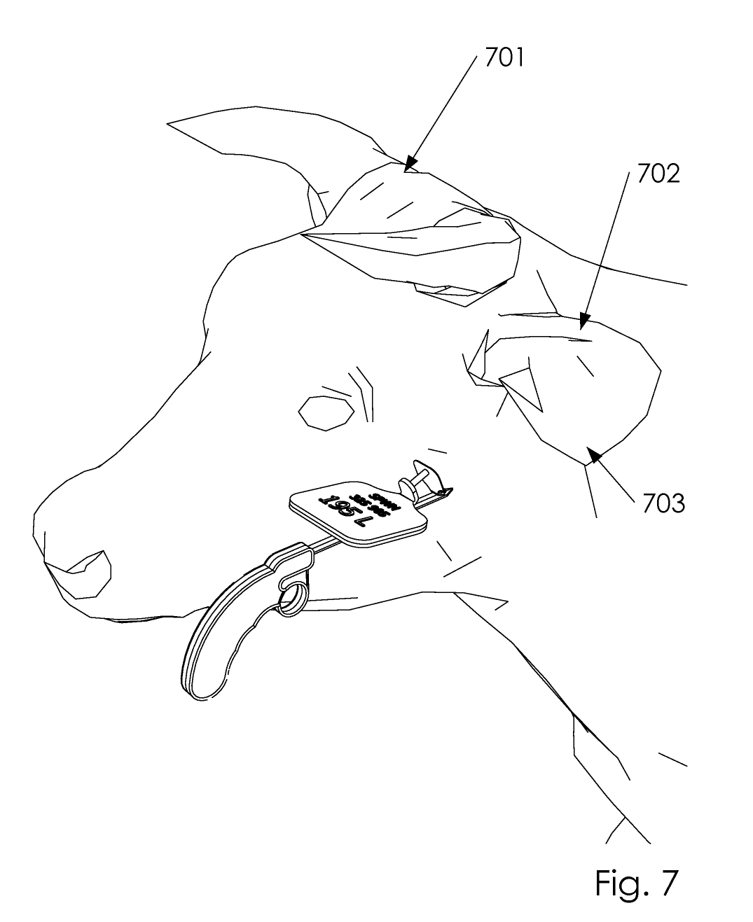

FIG. 7 illustrates a bovine 701 and animal ear tag 100 with applicator 500 in said pre-application position. In one embodiment, animal ear tag 100 can attach to an animal. For example, in one embodiment, said animal can comprise cattle, sheep, pigs, horses and other animals. Further, in another embodiment, said animal can comprise bovine 701. Bovine 701 can comprise an ear 702. Ear 702 can comprise an ear-piercing location 703. In one embodiment, ear-piercing location 703 can be in a lower lobe of ear 702. In one embodiment, animal ear tag 100 and applicator 500 can be in said pre-application position; wherein animal ear tag 100 can be attached to bovine 701 by aligning blade tip 503 with ear-piercing location 703, piercing ear 702 with blade tip 503, pushing blade 501 through ear 702 until hook 504 and slot 204 have also passed through ear 702, pulling applicator 500 out of ear 702 leaving behind animal ear tag 100.

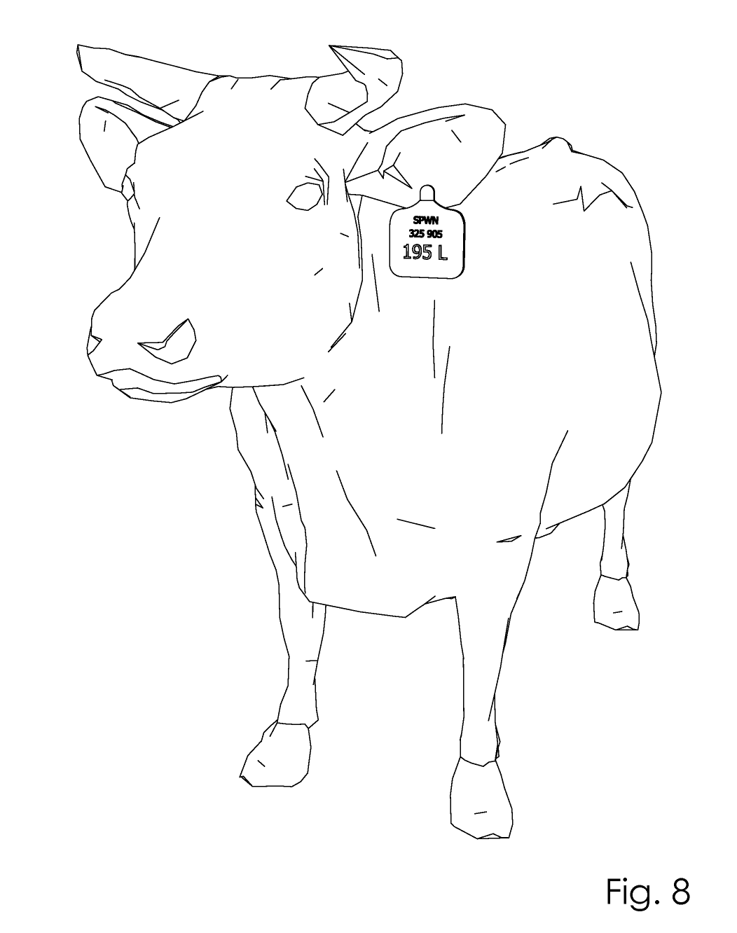

FIG. 8 illustrates animal ear tag 100 attached to bovine 701.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A system for maintaining animal ear tags comprising an animal ear tag; wherein said animal ear tag comprises:
a body having a first side and a second side,
a control chemical,
one or more identifiers, and
an ear attachment assembly capable of attaching to an ear of an animal; further wherein
said body and said ear attachment assembly are one-piece.

2. The system for maintaining animal ear tags of claim 1 wherein said animal ear tag further comprises a control chemical element; wherein said control chemical element is made by molding a compound of a plastic and said control chemical.

3. The system for maintaining animal ear tags of claim 1 wherein said control chemical is added to said animal ear tag by a dipping procedure; wherein said dipping procedure comprises
heating a portion of said system for maintaining animal ear tags,
dipping said portion in said control chemical,
removing said portion from said control chemical, and
allowing said portion to cool.

4. The system for maintaining animal ear tags of claim 1 wherein said control chemical comprises a pesticide.

5. The system for maintaining animal ear tags of claim 1 wherein said control chemical comprises a medication.

6. The system for maintaining animal ear tags of claim 1 wherein said control chemical comprises a multivitamin.

7. The system for maintaining animal ear tags of claim 1 wherein said identifiers comprise an electronic identifier capable of being read by an electronic reader.

8. The system for maintaining animal ear tags of claim 7 wherein said electronic identifier comprises a RFID tag and said electronic reader comprises a RFID reader capable of electronically reading said RFID tag.

9. The system for maintaining animal ear tags of claim 1 wherein said identifiers comprise a printed identifier on said body and said printed identifier is capable of visual interpretation.

10. The system for maintaining animal ear tags of claim 9 wherein said printed identifier on a medium and said medium is attached to said body.

11. The system for maintaining animal ear tags of claim 10 wherein said medium and said body are attached to one another with a set of hook-and-loop fasteners.

12. The system for maintaining animal ear tags of claim 10 wherein said medium is a piece of tape with said printed identifier on said piece of tape.

13. The system for maintaining animal ear tags of claim 9 wherein said printed identifier comprises a barcode capable of being read by a barcode reader.

14. The system for maintaining animal ear tags of claim 2 further comprising:
attaching said control chemical element to said second side of said body;
attaching a printed identifier to said first side of said body with a transfer procedure; and
insulating said control chemical element from said transfer procedure with said body; further wherein,
said identifiers comprise said printed identifier, and
said printed identifier is capable of visual interpretation.

15. A method for maintaining animal ear tags comprising:
attaching one or more identifiers to an animal ear tag having a body and an ear attachment assembly, and
attaching said ear attachment assembly to an ear of an animal; wherein
said body and said ear attachment assembly are one-piece, and
a portion of said animal ear tag comprises a control chemical capable of protecting said animal.

16. The method for maintaining animal ear tags of claim 15 further comprising
attaching a control chemical element to said animal ear tag wherein said control chemical element comprises said control chemical.

17. The method for maintaining animal ear tags of claim 16 wherein said identifiers comprise an electronic identifier capable of being read by an electronic reader.

18. The method for maintaining animal ear tags of claim 16 wherein said identifiers comprise a printed identifier on said body and said printed identifier is capable of visual interpretation.

19. The method for maintaining animal ear tags of claim 18 further comprising transferring said printed identifier using a transfer procedure; wherein said transfer procedure comprises
heating a stamp having a printed identifier mirror image,
pressing said mirror image of said printed identifier against a first side of said transfer paper,
pressing a second side of said transfer paper against said body with said stamp,
releasing a portion of said transfer paper on said body wherein said portion of said transfer paper comprises said printed identifier.

20. The method for maintaining animal ear tags of claim 19 further comprising minimizing heat damage to said control chemical element during said transfer procedure by
attaching said control chemical element to a second side of said body,
transferring said printed identifier to a first side of said body, and
insulating said control chemical element during said transfer procedure with said body.
